(19) United States
(12) Patent Application Publication
(10) Pub. No.: US 2022/0215411 A1
(43) Pub. Date: Jul. 7, 2022

(54) DEMAND PREDICTION DEVICE

(71) Applicant: NTT DOCOMO, INC., Chiyoda-ku (JP)

(72) Inventors: Kenji SHINODA, Chiyoda-ku (JP); Masato YAMADA, Chiyoda-ku (JP); Yusuke FUKAZAWA, Chiyoda-ku (JP)

(73) Assignee: NTT DOCOMO, INC., Chiyoda-ku (JP)

(21) Appl. No.: 17/609,864

(22) PCT Filed: May 8, 2020
(86) PCT No.: PCT/JP2020/018721

§ 371 Date: Nov. 9, 2021

(30) Foreign Application Priority Data
May 13, 2019 (JP) 2019-090439

(51) Int. Cl. G06Q 30/02

(52) U.S. Cl. CPC G06Q 30/0202

(57) ABSTRACT

An object is to predict a more accurate demand. A demand prediction device (1) includes an information storing unit (10) configured to store a plurality of demand prediction models, each of the demand prediction models being a prediction model configured to predict a demand in a demand state relating to demand and differing between each demand prediction model and a state prediction model that is a prediction model predicting a state degree that is a degree to which a designated timing is applicable to each demand state; and a demand predicting unit (15) configured to predict a demand on the basis of the demands predicted by the plurality of demand prediction models stored by the information storing unit (10) and the state degree predicted by the state prediction model stored by the information storing unit (10).

### TECHNICAL FIELD

One aspect of the present disclosure relates to a demand prediction device that predicts a demand.

### BACKGROUND ART

In Patent Literature 1 described below, a customer/sales prediction device that predicts the number of customers and sales of a restaurant and the like is disclosed.

### CITATION LIST

### Patent Literature

[Patent Literature 1] Japanese Unexamined Patent Publication No. H05-189406

### SUMMARY OF INVENTION

### Technical Problem

Prediction of demands such as the numbers of customers and sales amounts of facilities such as restaurants is an important task for shift scheduling of staff and advance preparation of the facilities. Particularly, in operating facilities, occurrence of unusual situations such as a high demand and a low demand that are triggered by events or climates is requested to be predicted in advance. However, in technologies of the related art, it is difficult to predict an accurate demand in an unusual situation.

One aspect of the present disclosure is in view of such problems and an object thereof is to provide a demand prediction device capable of predicting a more accurate demand.

### Solution to Problem

In order to solve the problems described above, according to one aspect of the present disclosure, there is provided a demand prediction device including: a storage unit configured to store a plurality of demand prediction models, each of the demand prediction models being a prediction model configured to predict a demand in a demand state relating to demand and differing between each demand prediction model and a state prediction model that is a prediction model predicting a state degree that is a degree to which a designated timing is applicable to each demand state; and a prediction unit configured to predict a demand on the basis of the demands predicted by the plurality of demand prediction models stored by the storage unit and the state degree predicted by the state prediction model stored by the storage unit.

According to such a demand prediction device, a demand is predicted on the basis of demands predicted for demand states that differ for the respective demand prediction models by the plurality of demand prediction models and a state degree that is applicable to each demand state predicted by the state prediction model, and thus a more accurate demand reflecting the demands predicted for various demand states and the state degree that is applicable to each demand state can be predicted.

### Advantageous Effects of Invention

According to one aspect of the present disclosure, a more accurate demand can be predicted.

### BRIEF DESCRIPTION OF DRAWINGS

FIG. 1 is a schematic diagram of a demand prediction using a demand prediction device according to an embodiment of the present invention.

FIG. 2 is a functional block diagram of a demand prediction device according to an embodiment of the present invention.

FIG. 3 is a diagram illustrating an example of a table of learning data for a demand prediction model.

FIG. 4 is a diagram illustrating an example of a table of a demand distribution.

FIG. 5 is a diagram illustrating an example of a table of learning data for a state prediction model for determining a high demand state.

FIG. 6 is a diagram illustrating an example of a table of learning data for a state prediction model for determining a low demand state.

FIG. 7 is a diagram illustrating an example of a table of prediction data for a demand prediction model.

FIG. 8 is a diagram illustrating an example of a table of prediction data for a state prediction model for determining a high demand state.

FIG. 9 is a diagram illustrating an example of a table of prediction data of a state prediction model for determining a low demand state.

FIG. 10 is a flowchart illustrating a prediction model generating process performed by a demand prediction device according to an embodiment of the present invention.

FIG. 11 is a flowchart illustrating a demand predicting process performed by a demand prediction device according to an embodiment of the present invention.

FIG. 12 is a hardware configuration diagram of a demand prediction device according to an embodiment of the present invention.

### DESCRIPTION OF EMBODIMENTS

Hereinafter, a demand prediction device according to an embodiment will be described in detail with reference to the drawings. In description of the drawings, the same reference signs will be assigned to the same elements, and duplicate description will be omitted. The embodiment in the description presented below is a specific example of the present invention, and the present invention is not limited to this embodiment unless there is description indicating that it limits the present invention.

A demand prediction device 1 according to this embodiment is a computer device that predicts a demand (performs a demand prediction). A demand is a desire for a product, a service, or the like supported by purchasing power or a total social amount of the desire. Although the demand is assumed to be the number of customers, a sales amount, the number of sold items, or the like at a facility such as a restaurant in this embodiment, the demand is not limited thereto.

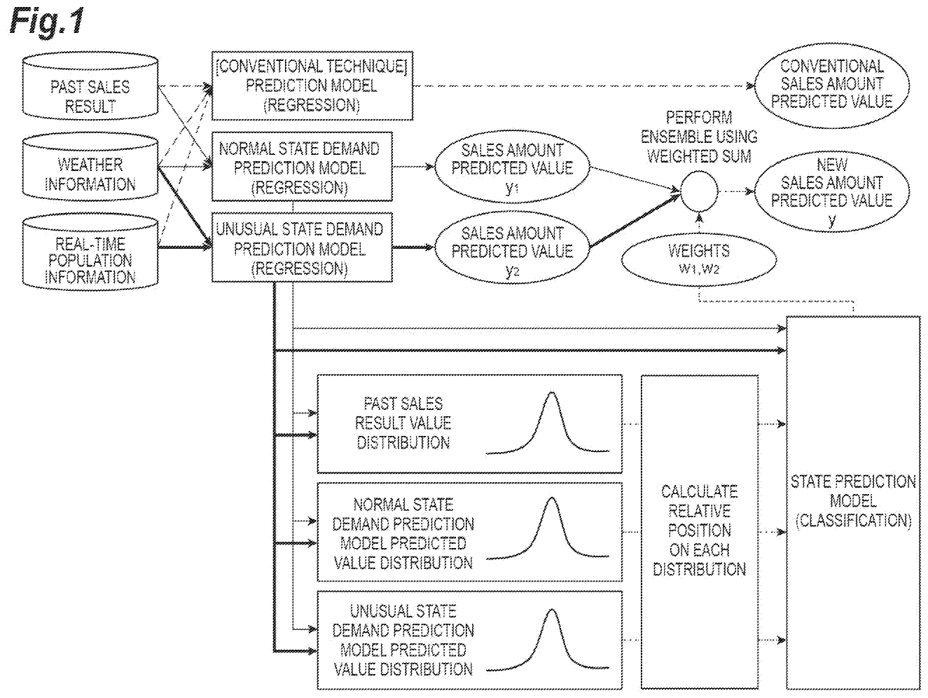

An overview of a demand prediction using the demand prediction device 1 will be described with reference to FIG. 1 in comparison with a conventional technique. FIG. 1 is a schematic diagram of a demand prediction using the demand prediction device 1. As illustrated in FIG. 1, in the related art, a prediction model for predicting a sales amount is generated by performing learning using sales results of the past (past sales results), weather information, and population information of real time (real-time population information) as learning data, and a predicted value of a sales amount (a predicted conventional sales amount value) at a timing (a prediction target date and time or the like) that is designated (by a user of the demand prediction device 1 or the like) is calculated using the generated prediction model. In the related art, a demand is predicted using one prediction model, that is, a single model.

On the other hand, in a demand prediction using the demand prediction device 1, a demand is predicted using a plurality of prediction models including a normal state demand prediction model and an unusual state demand prediction model to be described below, that is, multiple models, and using a state prediction model that is a prediction model to be described below. More specifically, first, by performing learning using past sales results and the like as learning data, the demand prediction device 1 generates a normal state demand prediction model for predicting a demand in a case in which the demand state, which is a state relating to a demand, is a normal state, for example, a normal state that is an average demand state. Next, by performing learning using weather information, real-time population information, and the like as learning data, the demand prediction device 1 generates an unusual state demand prediction model for predicting a demand in a case in which the demand state is an unusual state, for example, an unusual state other than an average demand state such as a high demand or a low demand that is triggered by an event or weather.

Next, the demand prediction device 1 generates a past sales result value distribution that is a probability distribution of past sales result values on the basis of past sales results and the like. Next, the demand prediction device 1 generates a normal state demand prediction model predicted value distribution that is a probability distribution of sales amount predicted values calculated by the normal state demand prediction model and an unusual state demand prediction model predicted value distribution that is a probability distribution of sales amount predicted values calculated by the unusual state demand prediction model on the basis of the sales amount predicted values calculated by the normal state demand prediction model, the sales amount predicted values calculated by the unusual state demand prediction model, and the like.

Next, by performing learning using a sales amount predicted value y₁ calculated by the normal state demand prediction model for a timing (a prediction target date and time or the like) that is designated (by a user of the demand prediction device 1 or the like), a sales amount predicted value y₂ calculated by the unusual state demand prediction model for the designated timing, relative positions of the sales amount predicted value y₁ and the sales amount predicted value y₂ on the past sales result value distribution, relative positions of the sales amount predicted value y₁ and the sales amount predicted value y₂ on the normal state demand prediction model predicted value distribution for the designated timing, relative positions of the sales amount predicted value y₁ and the sales amount predicted value y₂ on the unusual state demand prediction model predicted value distribution for the designated timing, and the like, the demand prediction device 1 generates a state prediction model for predicting a state degree (a weighting factor) that is a degree to which a designated timing is applicable to each of demand states of the normal state and the unusual state.

Next, the demand prediction device 1 calculates a new sales amount predicted value y that is a predicted value of sales by performing ensemble of a weighted sum of a state degree w₁ that is applicable to a high demand state that is a high demand state relative to the normal state among unusual states and a state degree w₂ that is applicable to a low demand state that is a low demand state relative to the normal state among the unusual states, in which the state degrees w₁ and w₂ are calculated by the state prediction model for the sales amount predicted value y₁ and the sales amount predicted value y₂. For example, calculation of the new sales amount predicted value y may be based on the following equation.

y=((w₁y₊+(1−w₁)y₋)+(w₂y₋+(1−w₂)y₊))/2

Here, y₊ and y₋ are based on the following equations.

y₊=max(y₁, y₂)

y₋=min(y₁, y₂)

In addition, when a state prediction model is generated, in a normal state, a case in which a large upward oscillation occurs is labeled as “1,” a case in which a large downward oscillation occurs is labeled as “−1,” a model classifying and predicting whether “1” is true or false and a model classifying and predicting whether “−1” is true or false may be generated, and scores output respectively by the models at the time of prediction may be referred to as w₁ and w₂.

In a single model of a technique of the related art, it is difficult to acquire both prediction accuracies for demands of a normal state and an unusual state, and the demand prediction device 1 divides the prediction model into the normal state demand prediction model and the unusual state demand prediction model. The demand prediction device 1 predicts whether a prediction target date and time has a higher possibility of being a normal state or an unusual state using a state prediction model that is another prediction (classification) model and derives a new sales amount predicted value using a weighted sum of predicted values (state degrees). In addition, the number of prediction models after division is not limited to two and may be three or more.

An overview of the demand prediction using the demand prediction device 1 has been described as above. Next, details of the demand prediction device 1 will be described.

FIG. 1 is a functional block diagram of the demand prediction device 1. As illustrated in FIG. 1, the demand prediction device 1 is configured to include an information storing unit 10 (storage unit), a normal state demand prediction model generating unit 11, an unusual state demand prediction model generating unit 12, a demand distribution generating unit 13, a state prediction model generating unit 14 (generating unit), and a demand predicting unit 15 (prediction unit).

Although each functional block of the demand prediction device 1 is assumed to function inside the demand prediction device 1, the configuration is not limited thereto. For example, some of functional blocks of the demand prediction device 1 may be configured as a computer device different from the demand prediction device 1 and may function while appropriately transmitting/receiving information to/from the demand prediction device 1 inside a computer device connected to the demand prediction device 1 via a network. In addition, some of the functional blocks of the demand prediction device 1 may be omitted, a plurality of functional blocks may be integrated into one functional block, or one functional block may be divided into a plurality of functional blocks.

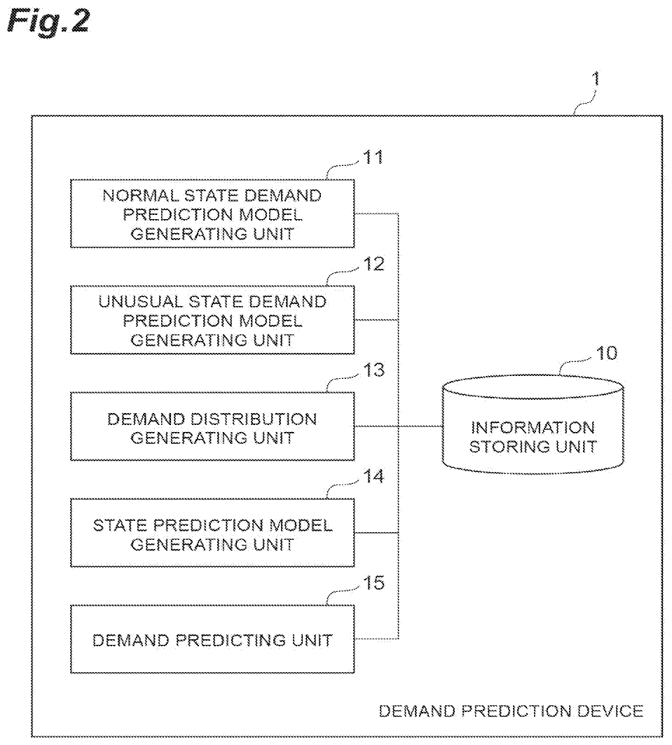

Hereinafter, each functional block of the demand prediction device 1 illustrated in FIG. 2 will be described.

The information storing unit 10 stores a plurality of demand prediction models in which each demand prediction model, which is a prediction model, among a plurality of (two or more) demand prediction models predicts a demand in a demand state, which is a state relating to a demand, that differs for each demand prediction model. The plurality of demand prediction models may include at least one of a prediction model for predicting a demand in a case in which the demand is in a normal state and a prediction model for predicting a demand in a case in which the demand is in an unusual state. In this embodiment, the information storing unit 10 stores a normal state demand prediction model and an unusual state demand prediction model. A normal state that is a demand state targeted by the normal state demand prediction model and an unusual state that is a demand state targeted by the unusual state demand prediction model are different from each other. The information storing unit 10 may store a normal state demand prediction model in advance on the basis of an instruction of a user of the demand prediction device 1 or may store a normal state demand prediction model generated by the normal state demand prediction model generating unit 11 to be described below. Similarly, the information storing unit 10 may store an unusual state demand prediction model in advance on the basis of an instruction of a user of the demand prediction device 1 or may store an unusual state demand prediction model generated by the unusual state demand prediction model generating unit 12 to be described below.

The information storing unit 10 stores a state prediction model that is a prediction model for predicting a state degree with which a designated timing is applicable to each demand state. More specifically, the information storing unit 10 stores a state prediction model for predicting a state degree with which a timing (a prediction target date and time or the like) that is designated (by a user of the demand prediction device 1 or the like) is applicable to the normal state and the unusual state that are respective demand states. The information storing unit 10 may store a state prediction model in advance on the basis of an instruction of a user of the demand prediction device 1 or may store a state prediction generated by the state prediction model generating unit 14 to be described below.

The information storing unit 10 may store information that is necessary for each process inside the demand prediction device 1 or may store information generated in each corresponding process in addition to the state prediction model described above.

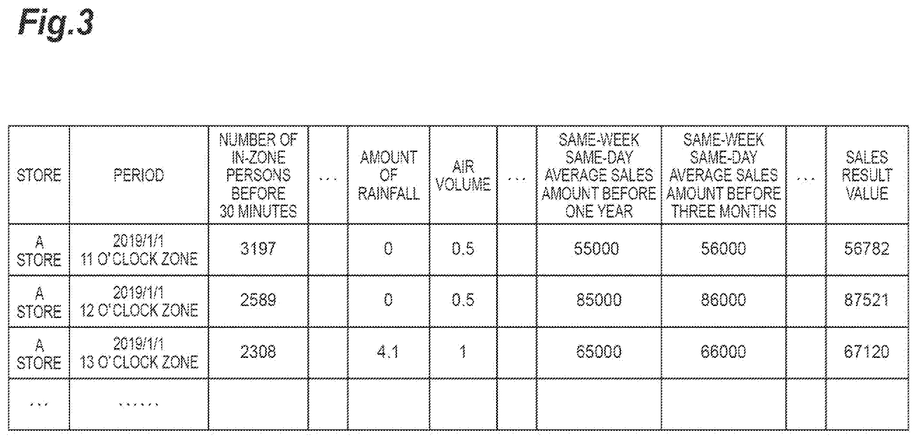

The normal state demand prediction model generating unit 11 generates a normal state demand prediction model by performing learning using learning data (past data) for demand prediction models including the normal state demand prediction model and the unusual state demand prediction model and causes the information storing unit 10 to store the generated normal state demand prediction model. FIG. 3 is a diagram illustrating an example of a table of learning data for a demand prediction model. As illustrated in FIG. 3, in the learning data for a demand prediction model, a store (a store name used for identifying the store), a period, the number of in-zone persons (real-time population information) in the vicinity of the store 30 minutes before the corresponding period, the amount of rainfall in the vicinity of the store for the period, an air volume in the vicinity of the store for the period, an average sales amount of the same week and the same day one year before the period (a one-year-before same-week same-day average sales amount) at the store, a same-week same-day average sales amount three months before the period (a three-months-before same-week same-day average sales amount) at the store, and a result value of the sales amount of the period at the store are associated with each other. In the learning data for a demand prediction model, the amount of rainfall and the air volume are weather information, the one-year-before same-week same-day average sales amount and the three-months-before same-week same-day average sales amount are sales result statistical amounts, and the weather information and the sales result statistical amounts are learning feature quantities.

By performing learning using the learning data for a demand prediction model, the normal state demand prediction model generating unit 11 generates a normal state demand prediction model capable of calculating a predicted value of a sales amount at an arbitrary timing. By performing learning mainly using a same-week same-day average sales amount before one year and a same-week same-day average sales amount before three months that are period components of periodical components (feature quantities: corresponding to a column of the example of the table illustrated in FIG. 3) in the learning data for a demand prediction model, the normal state demand prediction model generating unit 11 may generate a normal state demand prediction model for predicting a demand in the normal state. In addition, the normal state demand prediction model generating unit 11 may further learn one or more components other than the period components in addition to the period components.

The unusual state demand prediction model generating unit 12 generates an unusual state demand prediction model by performing learning using the learning data for a demand prediction model and causes the information storing unit 10 to store the generated unusual state demand prediction model. Describing using the learning data for a demand prediction model illustrated in FIG. 3, the unusual state demand prediction model generating unit 12 generates an unusual state demand prediction model capable of calculating a predicted value of a sales amount at an arbitrary timing by performing learning using the learning data for a demand prediction model. The unusual state demand prediction model generating unit 12 may generate an unusual state demand prediction model for predicting a demand in an unusual state by performing learning mainly using the number of in-zone persons 30 minutes before, the amount of rainfall, and the air volume, which are short-term variation components of components varying in a short term, in the learning data for a demand prediction model. In addition, the unusual state demand prediction model generating unit 12 may further learn one or more components other than the short-term variation components in addition to the short-term variation components.

The demand distribution generating unit 13 generates a demand distribution that is a demand probability distribution and causes the information storing unit 10 to store the generated demand distribution. The demand distribution generating unit 13 may generate a demand distribution on the basis of demands predicted by each of a plurality of demand prediction models. For example, a demand distribution is a probability distribution of demands at a certain time on a certain day for a certain store and may be represented using a two-dimensional graph having a sales amount as an x axis and a frequency as a y axis.

The demand distribution generating unit 13 generates a past sales result value distribution that is a probability distribution of past sales result values on the basis of past sales results and the like. For example, when various kinds of population statistics data, weather data, and sales amount data are included as learning data from Jan. 1, 2016, to Dec. 31, 2018, a sales amount from Jan. 1, 2018, to Dec. 31, 2018, is desired to be predicted using the learning data from Jan. 1, 2016, to Dec. 31, 2017, for learning. In such a case, the demand distribution generating unit 13 generates a past sales result value distribution using the sales results from Jan. 1, 2016, to Dec. 31, 2017.

The demand distribution generating unit 13 generates a normal state demand prediction model predicted value distribution and an unusual state demand prediction model predicted value distribution on the basis of a sales amount predicted value calculated by the normal state demand prediction model stored by the information storing unit 10 and a sales amount predicted value calculated by the unusual state demand prediction model stored by the information storing unit 10, and the like. In the case of the example of the learning data described above, the demand distribution generating unit 13 generates a normal state demand prediction model predicted value distribution and an unusual state demand prediction model predicted value distribution using a sales amount predicted value calculated by the normal state demand prediction model using learning data from Jan. 1, 2016, to Dec. 31, 2017, and a sales amount predicted value calculated by the unusual state demand prediction model using the learning data. A sales amount predicted value from Jan. 1, 2018, to Dec. 31, 2018, that is the original prediction target is not used for the generation of demand distributions.

The sales amount of a store changes for each store, for each time, and for each day. For example, when a store near an ongoing event at 12:00 d and a store near a quiet residential section at 15:00 are put on the same scale, the latter constantly belongs to a low demand zone. When the demand distribution generating unit 13 generates demand distributions, the demand distributions are generated with the same condition such as the same time and the same day at the same store

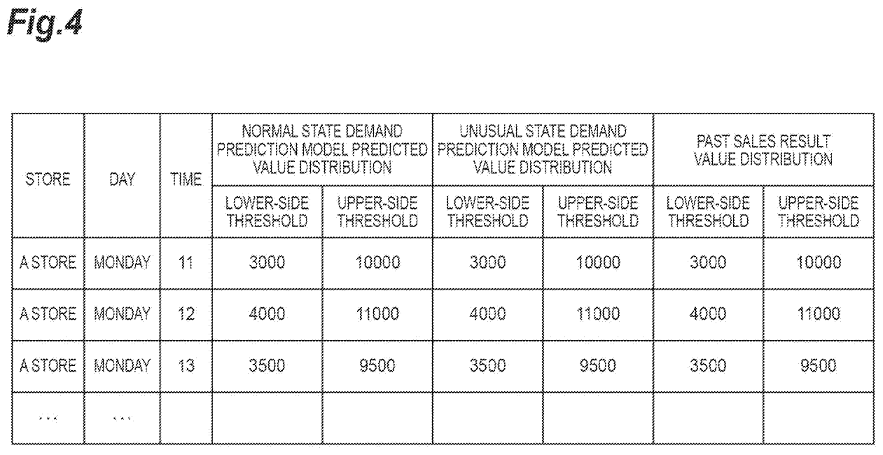

FIG. 4 is a diagram illustrating an example of a table of a demand distribution generated by the demand distribution generating unit 13. As illustrated in FIG. 4, in a demand distribution, a store, a day, a time, a lower threshold and an upper threshold of a normal state demand prediction model predicted value distribution on a corresponding day and at a corresponding time in the vicinity of the corresponding store, a lower threshold and an upper threshold of an unusual state demand prediction model predicted value distribution on the corresponding day and at the corresponding time in the vicinity of the corresponding store, and a lower threshold and an upper threshold of a past sales result value distribution on the corresponding day and at the corresponding time in the vicinity of the corresponding store are associated with each other. Here, an upper threshold is a threshold in the x-axis direction (sales amount) that is regarded as a high demand zone in each distribution. A lower threshold is a threshold in the x-axis direction that is regarded as a low demand zone in each distribution. For example, as a method for calculating each threshold, a mean in and a standard deviation σ of each distribution are calculated, the value of “m+1.2σ” is set as an upper threshold, and the value of “m−1.2σ” is set as a lower threshold. In accordance with this, a high demand zone and a low demand zone are defined, and in determination (classification) of an unusual state, it can be determined whether a value of a correct answer is present in the high demand zone or is present in the low demand zone.

The state prediction model generating unit 14 generates a state prediction model. The state prediction model may be a prediction model that is generated on the basis of a demand distribution (for example, a normal state demand prediction model predicted value distribution, an unusual state demand prediction model predicted value distribution, and a past sales result value distribution). The state prediction model may be a prediction model that is generated on the basis of a position of a demand predicted by each of a plurality of demand prediction models (for example, the normal state demand prediction model and the unusual state demand prediction model) in the demand distribution. In generating a state prediction model, the state prediction model generating unit 14 may generate learning data for a state prediction model. The state prediction model generating unit 14 may cause the information storing unit 10 to store the learning data for the generated state prediction model and the state prediction model.

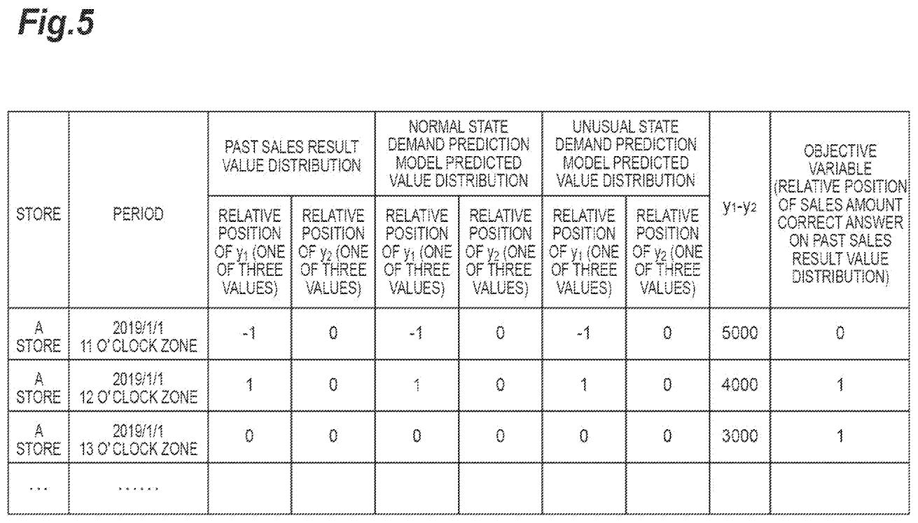

FIG. 5 is a diagram illustrating an example of a table of learning data for a state prediction model, which is generated by the state prediction model generating unit 14, for determining a high demand state. As illustrated in FIG. 5, in the learning data for a state prediction model for determining a high-demand state, a store, a period, a relative position of y₁ and a relative position of y₂ in a past sales result value distribution, a relative position of y₁ and a relative position of y₂ in a normal state demand prediction model predicted value distribution, a relative position of y₁ and a relative position of y₂ in an unusual state demand prediction model predicted value distribution, a difference (y₁−y₂) between y₁ and y₂, and a relative position of a sales amount correct answer, which is an objective variable, in the past sales result value distribution are associated with each other. Here, as described above, y₁ is a sales amount predicted value y₁ calculated by the normal state demand prediction model for a designated timing (a prediction target date and time or the like). Similarly, y₂ is a sales amount predicted value y₂ calculated by the unusual state demand prediction model for a designated timing. In addition, for each distribution illustrated in the example of the table illustrated in FIG. 4, a relative position is set to “1” in a case in which the sales amount predicted value y₁ is equal to or larger than the upper threshold, is set to “−1” in a case in which the sales amount predicted value y₁ is equal to or smaller than the lower threshold, and is set to “0” in a case in which the sales amount predicted value y₁ is between the upper threshold and the lower threshold. In other words, the relative position has one of three values. As the objective variable, a sales amount log for a corresponding period registered in a point of sales (POS) system present at a corresponding store is acquired through the demand prediction device 1 or manually, correct answer data is calculated by automatically performing a collection process for the acquired data using the demand prediction device 1, a relative position is calculated for the past sales result value distribution using the state prediction model generating unit 14, a low demand state and an intermediate demand state are set to “0,” and a high-demand state is set to “1.”

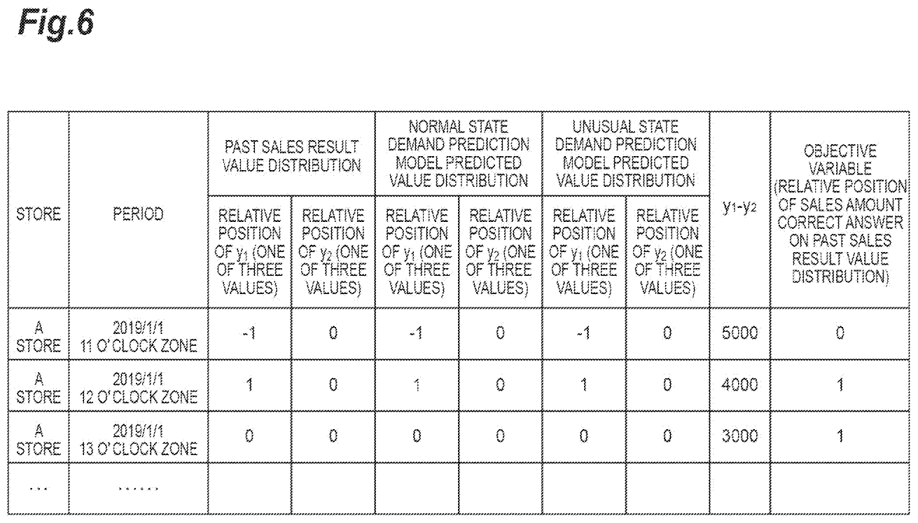

FIG. 6 is a diagram illustrating an example of a table of learning data for a state prediction model, which is generated by the state prediction model generating unit 14, for determining a low demand state. Describing a difference from the example of the table illustrated in FIG. 5, in the example of the table illustrated in FIG. 6, as an objective variable, in the calculated relative position, a high demand state and an intermediate demand state are set to “0,” and a low demand state is set to “1.”

In this embodiment, although the learning data for a state prediction model generated by the state prediction model generating unit 14 is separately generated for a state prediction model for determining a high demand state and a state prediction model for determining a low demand state, binary classification learning is performed for each thereof, and a classification score at a prediction time point is calculated, one state prediction model may be generated without any division, and learning and calculation may be performed.

The state prediction model generating unit 14 generates a state prediction model by performing learning using the generated learning data for a state prediction model. For example, the state prediction model generating unit 14 generates a state prediction model for predicting a probability (state degree) of a designated timing being in the high demand state by performing learning using the learning data for a state prediction model for determining a high demand state that has been generated as described above. In addition, for example, the state prediction model generating unit 14 generates a state prediction model for predicting a probability (state degree) of a designated timing being in the low demand state by performing learning using the learning data for a state prediction model for determining a low demand state that has been generated as described above.

The demand predicting unit 15 predicts a demand on the basis of a demand predicted by each of a plurality of demand prediction models (for example, the normal state demand prediction model and the unusual state demand prediction model) stored by the information storing unit 10 and a state degree predicted by the state prediction model stored by the information storing unit 10. The demand predicting unit 15 may predict a demand on the basis of a demand predicted by each of a plurality of demand prediction models for a designated timing and a state degree predicted by the state prediction model for the corresponding timing. The demand predicting unit 15 may predict a demand by weighting a state degree predicted by the state prediction model for a demand predicted by each of a plurality of demand prediction models. The demand predicting unit 15 may output (display) the predicted demand to a user of the demand prediction device 1 or may output the predicted demand to another computer device via a network.

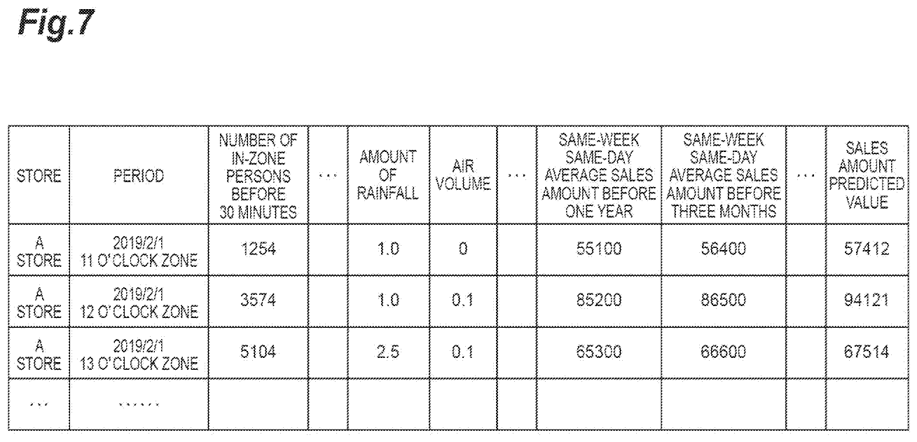

When the normal state demand prediction model predicts a demand, the demand predicting unit 15 applies prediction data. FIG. 7 is a diagram illustrating an example of a table of prediction data for a demand prediction model. For example, the demand predicting unit 15 inputs a same-week same-day sales amount average before one year relating to a timing designated as a prediction feature quantity and a same-week same-day average sales amount before three months (corresponding to the sales result value illustrated in FIG. 3) and applies them to the normal state demand prediction model with a sales amount predicted value as a blank field, whereby a sales result value at the designated timing in the normal state is predicted.

When the unusual state demand prediction model predicts a demand, the demand predicting unit 15 applies prediction data. For example, the demand predicting unit 15 inputs an amount of rainfall (acquired on the basis of a weather forecast or the like) and an air volume (acquired on the basis of a weather forecast or the like) relating to a designated timing as prediction feature quantities (corresponding to the sales result value illustrated in FIG. 3) and applies them to the unusual state demand prediction model with the sales amount predicted value being a blank field, whereby a sales result value at the designated timing in the unusual state is predicted.

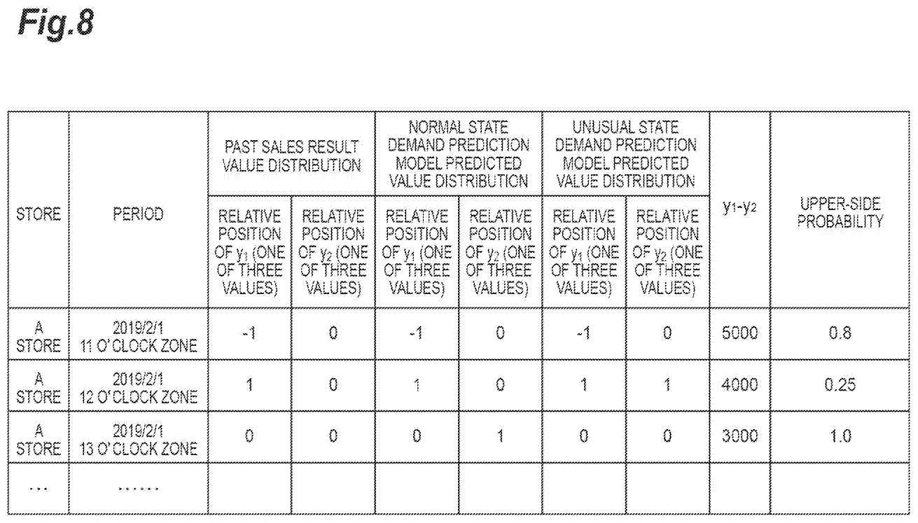

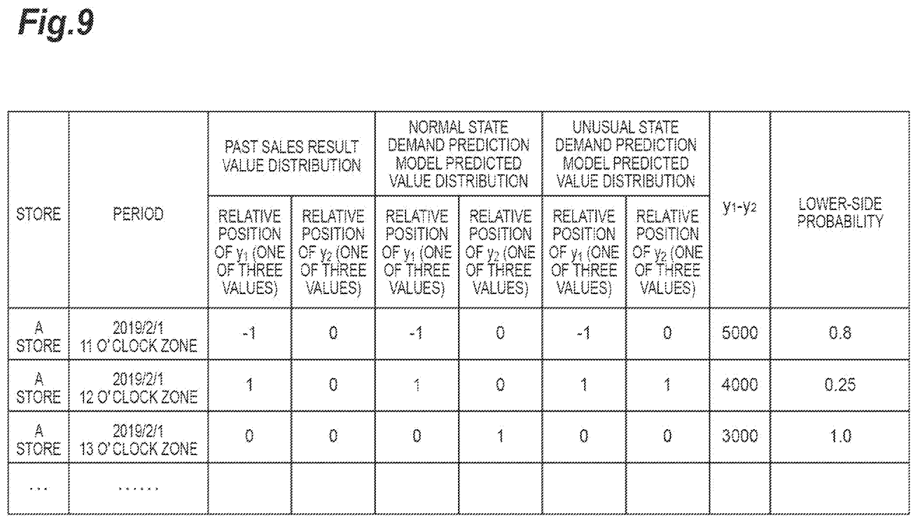

When the state prediction model predicts a state degree, the demand predicting unit 15 applies prediction data. FIG. 8 is a diagram illustrating an example of a table of prediction data for a state prediction model for determining a high demand state. As illustrated in FIG. 8, similar to the learning data illustrated in FIG. 5, by applying prediction data with a high-side probability (corresponding to an objective variable illustrated in FIG. 5) being a blank field relating to a designated timing to the state prediction model, the demand predicting unit 15 predicts a high-side probability (a state degree of a high demand state) at the designated timing. FIG. 9 is a diagram illustrating an example of a table of prediction data for a state prediction model for determining a low demand state. As illustrated in FIG. 9, similar to the learning data illustrated in FIG. 6, by applying prediction data with a low-side probability (corresponding to an objective variable illustrated in FIG. 6) being a blank field relating to a designated timing to the state prediction model, the demand predicting unit 15 predicts a low-side probability (a state degree of a low demand state) at the designated timing.

The demand predicting unit 15 may predict a demand, as in the calculation equation of the new sales amount predicted value y described above, by performing ensemble using a weighted sum of a sales result value in the normal state, a sales result value in the unusual state, a state degree of the high-demand state, and a state degree of the low demand state at a designated timing that have been predicted as described above.

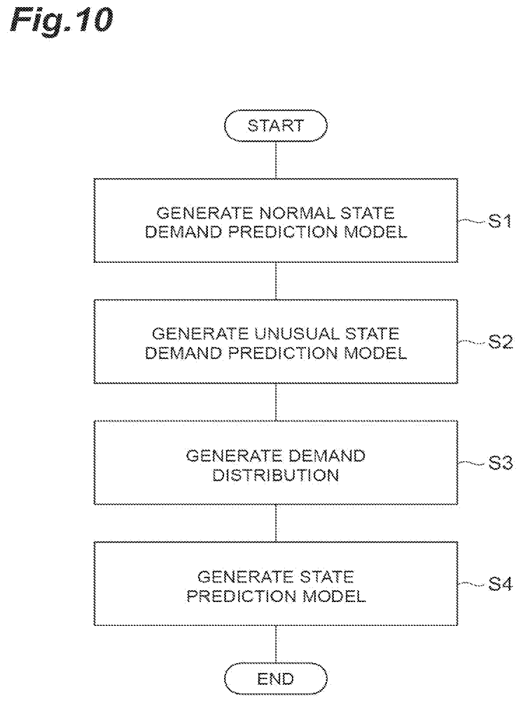

Subsequently, the process of a prediction model generating method performed by the demand prediction device 1 will be described using a flowchart illustrated in FIG. 10.

First, a normal state demand prediction model is generated by the normal state demand prediction model generating unit 11 (Step S1). Next, an unusual state demand prediction model is generated by the unusual state demand prediction model generating unit 12 (Step S2). Next, a demand distribution is generated by the demand distribution generating unit 13 on the basis of the normal state demand prediction model generated in S1 and the unusual state demand prediction model generated in S2 (Step S3). Next, a state prediction model is generated by the state prediction model generating unit 14 on the basis of the demand distribution generated in S3 (Step S4). The order of S1 and S2 may be reversed.

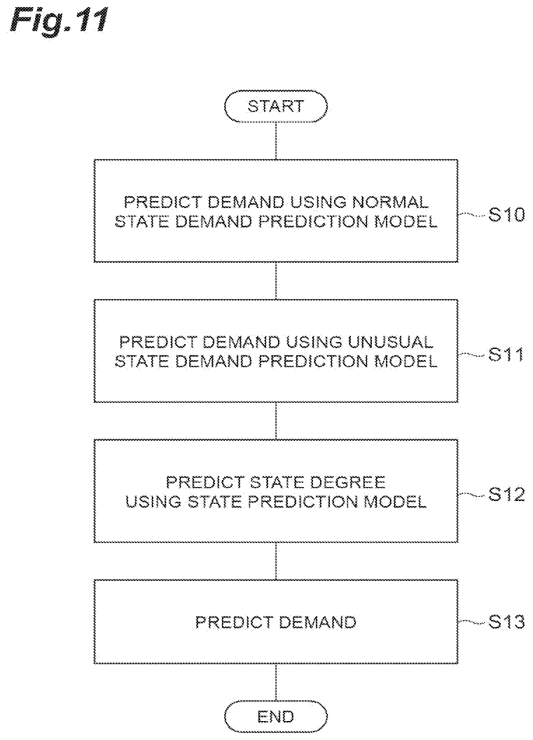

Next, the process of the demand prediction method performed by the demand prediction device 1 will be described using a flowchart illustrated in FIG. 11.

First, a demand in the normal state at a designated timing is predicted using the normal state demand prediction model (that has been generated and stored in advance) by the demand predicting unit 15 (Step S10). Next, a demand in the unusual state at a designated timing is predicted using the unusual state demand prediction model (that has been generated and stored in advance) by the demand predicting unit 15 (Step S11). Next, a state degree to which a designated timing is applicable to the normal state and the unusual state is predicted by the demand predicting unit 15 using the state prediction model (that has been generated and stored in advance) (Step S12). Next, a demand is predicted by the demand predicting unit 15 on the basis of the demand predicted in S10, the prediction predicted in S11, and the state degree predicted in S12 (Step S13).

Next, operations and effects of the demand prediction device 1 configured as in this embodiment will be described.

According to the demand prediction device 1 of this embodiment, a normal state demand prediction model, an unusual state demand prediction model, and a state prediction model are stored by the information storing unit 10, and a demand is predicted by the demand predicting unit 15 on the basis of demands predicted by the normal state demand prediction model and the unusual state demand prediction model that have been stored and a state degree predicted by the stored state prediction model. According to such a demand prediction device 1, a demand is predicted on the basis of demands predicted for demand states (the normal state and the unusual state) that differ for the respective demand prediction models by the normal state demand prediction model and the unusual state demand prediction model and a state degree that is applicable to each demand state predicted by the state prediction model, and thus a more accurate demand on which the demands predicted for the normal state and the unusual state and the state degree that is applicable to each demand state are reflected can be predicted.

In addition, according to the demand prediction device 1 of this embodiment, a demand may be predicted by the demand predicting unit 15 on the basis of demands predicted for a designated timing by the normal state demand prediction model and the unusual state demand prediction model and a state degree that is predicted by the state prediction model for the timing. According to such a demand prediction device 1, for example, a demand at an arbitrary timing at which a demand is desired to be predicted can be predicted.

In addition, according to the demand prediction device 1 of this embodiment, the state prediction model may be a prediction model that is generated on the basis of a demand distribution, which is a probability distribution of demands, based on demands predicted by the normal state demand prediction model and the unusual state demand prediction model. According to such a demand prediction device 1, a demand can be predicted using a demand distribution as an external factor, and thus a more accurate demand can be predicted.

In addition, according to the demand prediction device 1 of this embodiment, the state prediction model may be a prediction model that is generated on the basis of positions of demands predicted by the normal state demand prediction model and the unusual state demand prediction model in the demand distribution. According to such a demand prediction device 1, positions in the demand distribution can be easily calculated, and thus a demand can be predicted with a higher speed.

In addition, according to the demand prediction device 1 of this embodiment, a state prediction model may be generated by the state prediction model generating unit 14, and the generated state prediction model may be stored by the information storing unit 10. According to such a demand prediction device 1, a state prediction model can be easily generated or updated at an arbitrary timing, and thus a demand can be timely predicted.

In addition, according to the demand prediction device 1 of this embodiment, a demand may be predicted by weighting state degrees predicted by the state prediction model for demands predicted by the normal state demand prediction model and the unusual state demand prediction model using the demand predicting unit 15. According to such a demand prediction device 1, a demand in the normal state and a demand in the unusual state are weighted in accordance with state degrees thereof, and thus not only a demand in the normal state but also a demand in an unusual state such as a high demand or a low demand can be predicted more accurately.

In addition, according to the demand prediction device 1 of this embodiment, at least one of the normal state demand prediction model for predicting a demand in a case in which the demand is in the normal state and the unusual state demand prediction model for predicting a demand in a case in which the demand is in the unusual state may be included as a plurality of demand prediction models. According to such a demand prediction device 1, a more accurate demand with a demand in the normal state or a demand in the unusual state taken into account can be predicted.

Conventionally, a technique for estimating a future demand on the basis of past demand result data has been proposed. However, it is difficult to accurately predict a demand (value) in an unusual state such as a high demand or a low demand while whole accuracy is considered (maintained). According to the demand prediction device 1 of this embodiment, a demand (value) in an unusual state such as a high demand or a low demand also can be accurately predicted while whole accuracy is considered (maintained).

The demand prediction device 1 may be configured as below. In other words, a device that at least has a first model for predicting a demand value in a normal state as a numerical value using past demand values, a second model for predicting a demand value in an unusual state as a numerical value using the nearest number of persons expected to visit a store (and a weather forecast), and a third model for classifying and predicting whether a prediction target date and time is in the normal state or the unusual state and calculates a weighted sum of a first model output value and a second model output value using an unusual state occurrence probability output as a result of classification and prediction using the third model as weighting factors and outputs a result of the calculation as a demand prediction value. In addition, as explanatory variables (feature quantities) of the third model, for each of the first model output value and the second model output value, relative positions in a demand value distribution accumulated in the past, a first model output value distribution, and a second model output value distribution may be used.

The demand prediction device 1 relates to technologies of improvement of accuracy of high demand/low demand predictions according to ensemble of regression values using unusual state determination scores.

Each block diagram used for description of the embodiment described above illustrates blocks in units of functions. Such functional blocks (component units) are realized by an arbitrary combination of at least one of hardware and software. In addition, a method for realizing each functional block is not particularly limited. In other words, each functional block may be realized by one device that is combined physically or logically or a plurality of devices by directly or indirectly (for example, using a wire, wirelessly, or the like) connecting two or more devices separated physically or logically. A functional block may be realized by combining software with one device or the plurality of devices described above.

As functions, there are deciding, determining, judging, computing, calculating, processing, deriving, inspecting, searching, checking, receiving, transmitting, outputting, accessing, solving, selecting, choosing, establishing, comparing, assuming, expecting, regarding, broadcasting, notifying, communicating, forwarding, configuring, reconfiguring, allocating, mapping, assigning, and the like, and the functions are not limited thereto. For example, a functional block (constituent unit) enabling transmitting is referred to as a transmitting unit or a transmitter. As described above, a method for realizing all the functions is not particularly limited.

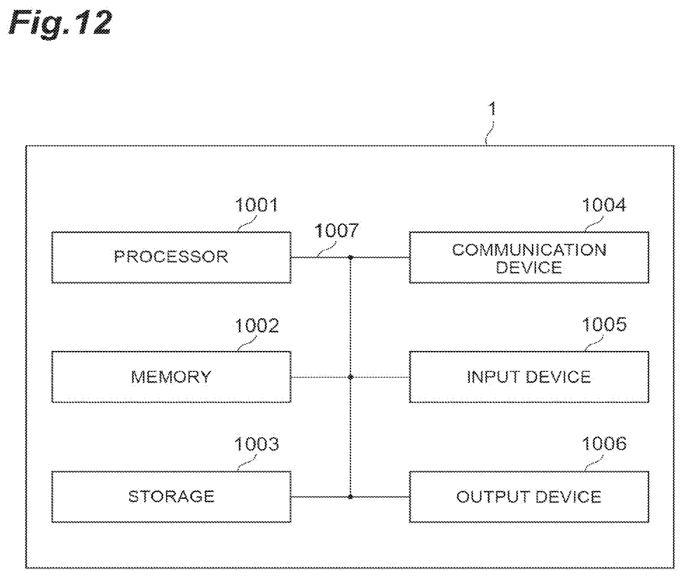

For example, the demand prediction device 1 according to one embodiment of the present disclosure may function as a computer that performs the process of the demand prediction of the present disclosure. FIG. 12 is a diagram illustrating one example of the hardware configuration of the demand prediction device 1 according to one embodiment of the present disclosure. The demand prediction device 1 described above, physically, may be configured as a computer device including a processor 1001, a memory 1002, a storage 1003, a communication device 1004, an input device 1005, an output device 1006, a bus 1007, and the like.

In addition, in the following description, a term “device” may be rephrased as a circuit, a device, a unit, or the like. The hardware configuration of the demand prediction device 1 may be configured to include one or a plurality of devices illustrated in the drawing and may be configured without including some of these devices.

Each function of demand prediction device 1 may be realized when the processor 1001 performs an arithmetic operation by causing predetermined software (a program) to be read onto hardware such as the processor 1001, the memory 1002, and the like, controls communication using the communication device 1004, and controls at least one of data reading and data writing for the memory 1002 and the storage 1003.

The processor 1001, for example, controls the entire computer by operating an operating system. The processor 1001 may be configured by a central processing unit (CPU) including an interface with peripheral devices, a control device, an arithmetic operation device, a register, and the like. For example, the normal state demand prediction model generating unit 11, the unusual state demand prediction model generating unit 12, the demand distribution generating unit 13, the state prediction model generating unit 14, the demand predicting unit 15, and the like described above may be realized by the processor 1001.

In addition, the processor 1001 reads a program (program code), a software module, data, and the like from at least one of the storage 1003 and the communication device 1004 into the memory 1002 and executes various processes in accordance with these. As the program, a program causing a computer to execute at least some of the operations described in the embodiment described above is used. For example, the normal state demand prediction model generating unit 11, the unusual state demand prediction model generating unit 12, the demand distribution generating unit 13, the state prediction model generating unit 14, and the demand predicting unit 15 may be realized by a control program that is stored in the memory 1002 and operated by the processor 1001, and the other functional blocks may be realized similarly. Although the various processes described above have been described as being executed by one processor 1001, the processes may be executed simultaneously or sequentially by two or more processors 1001. The processor 1001 may be realized using one or more chips. In addition, the program may be transmitted from a network through a telecommunication line.

The memory 1002 is a computer-readable recording medium and, for example, may be configured by at least one of a read only memory (ROM), an erasable programmable ROM (EPROM), an electrically erasable programmable ROM (EEPROM), a random access memory (RAM), and the like. The memory 1002 may be referred to as a register, a cache, a main memory (a main storage device), or the like. The memory 1002 can store a program (a program code), a software module, and the like executable for performing the radio communication method according to one embodiment of the present disclosure.

The storage 1003 is a computer-readable recording medium and, for example, may be configured by at least one of an optical disc such as a compact disc ROM (CD-ROM), a hard disk drive, a flexible disk, a magneto-optical disk (for example, a compact disc, a digital versatile disc, or a Blu-ray (registered trademark) disc), a smart card, a flash memory (for example, a card, a stick, or a key drive), a floppy (registered trademark) disk, a magnetic strip, and the like. The storage 1003 may be referred to as an auxiliary storage device. The storage medium described above, for example, may be a database including at least one of the memory 1002 and a storage 1003, a server, or any other appropriate medium.

The communication device 1004 is hardware (a transmission/reception device) for performing inter-computer communication through at least one of a wired network and a wireless network and, for example, may be called also a network device, a network controller, a network card, a communication module, or the like. The communication device 1004, for example, may be configured to include a high-frequency switch, a duplexer, a filter, a frequency synthesizer, and the like for realizing at least one of Frequency Division Duplex (FDD) and Time Division Duplex (TDD). For example, the normal state demand prediction model generating unit 11, the unusual state demand prediction model generating unit 12, the demand distribution generating unit 13, the state prediction model generating unit 14, the demand predicting unit 15, and the like described above may be realized by the communication device 1004.

The input device 1005 is an input device (for example, a keyboard, a mouse, a microphone, a switch, buttons, a sensor, or the like) that accepts an input from the outside. The output device 1006 is an output device (for example, a display, a speaker, an LED lamp, or the like) that performs output to the outside. In addition, the input device 1005 and the output device 1006 may have an integrated configuration (for example, a touch panel).

In addition, devices such as the processor 1001, the memory 1002, and the like are connected using a bus 1007 for communication of information. The bus 1007 may be configured as a single bus or buses different between devices.

In addition, the demand prediction device 1 may be configured to include hardware such as a microprocessor, a digital signal processor (DSP), an application specific integrated circuit (ASIC), a programmable logic device (PLD), a field programmable gate array (FPGA), or the like, and a part or the whole of each functional block may be realized by the hardware. For example, the processor 1001 may be mounted using at least one of such hardware components.

Notification of information is not limited to an aspect/embodiment described in the present disclosure and may be performed using a difference method.

Each aspect/embodiment described in the present disclosure may be applied to at least one of systems using Long Term Evolution (LTE), LTE-Advanced (LTE-A), Super 3G, IMT-Advanced, 4th generation mobile communication system (4G), 5th generation mobile communication (5G), Future Radio Access (FRA), New Radio (NR), W-CDMA (registered trademark), GSM (registered trademark), CDMA 2000, Ultra Mobile Broadband (UMB), IEEE 802.11 (Wi-Fi; registered trademark), IEEE 802.16 (WiMAX; registered trademark), IEEE 802.20, Ultra-WideBand (UWB), Bluetooth (registered trademark), and other appropriate systems and a next generation system extended based on these. In addition, a plurality of systems may be combined (for example, a combination of at least one of LTE and LTE-A and 5G or the like) and applied.

The processing sequence, the sequence, the flowchart, and the like of each aspect/embodiment described in the present disclosure may be changed in order as long as there is no contradiction. For example, in a method described in the present disclosure, elements of various steps are presented in an exemplary order, and the method is not limited to the presented specific order.

Information and the like may be output from an upper layer (or a lower layer) to a lower layer (or an upper layer). The information and the like may be input/output through a plurality of network nodes.

The input/output information and the like may be stored in a specific place (for example, a memory) or managed using a management table. The input/output information and the like may be overwritten, updated, or added to. The output information and the like may be deleted. The input information and the like may be transmitted to another device.

A judgment may be performed using a value (“0” or “1”) represented by one bit, may be performed using a Boolean value (true or false), or may be performed using a comparison between numerical values (for example, a comparison with a predetermined value).

The aspects/embodiments described in the present disclosure may be individually used, used in combination, or be switched therebetween in accordance with execution. In addition, a notification of predetermined information (for example, a notification of being X) is not limited to being performed explicitly and may be performed implicitly (for example, a notification of the predetermined information is not performed).

As above, while the present disclosure has been described in detail, it is apparent to a person skilled in the art that the present disclosure is not limited to the embodiments described in the present disclosure. The present disclosure may be modified or changed without departing from the concept and the scope of the present disclosure set in accordance with the claims. Thus, the description presented in the present disclosure is for the purpose of exemplary description and does not have any limited meaning for the present disclosure.

It is apparent that software, regardless of whether it is called software, firmware, middleware, a microcode, a hardware description language, or any other name, may be widely interpreted to mean a command, a command set, a code, a code segment, a program code, a program, a subprogram, a software module, an application, a software application, a software package, a routine, a subroutine, an object, an executable file, an execution thread, an order, a function, and the like.

In addition, software, a command, information, and the like may be transmitted and received via a transmission medium. For example, in a case in which software is transmitted from a website, a server, or any other remote source using at least one of a wiring technology (such as a coaxial cable, an optical fiber cable, a twisted pair, a digital subscriber line (DSL) or the like) and a radio technology (such as infrared rays, radio waves, microwaves, or the like), at least one of such a wiring technology and a radio technology is included in the definition of the transmission medium.

Information, a signal, and the like described in the present disclosure may be represented using any one among other various technologies. For example, data, a direction, a command, information, a signal, a bit, a symbol, a chip, and the like described over the entire description presented above may be represented using a voltage, a current, radiowaves, a magnetic field or magnetic particles, an optical field or photons, or an arbitrary combination thereof.

Furthermore, terms described in the present disclosure and terms that are necessary for the understanding of the present disclosure may be substituted with terms having the same or similar meanings.

Terms “system” and “network” used in the present disclosure are used interchangeably.

In addition, information, a parameter, and the like described in the present disclosure may be represented using absolute values, relative values from predetermined values, or other corresponding information. For example, a radio resource may be indicated using an index.

The names used for the parameters described above are not limited names in any aspect. In addition, equations and the like using such parameters may be different from those that are explicitly disclosed in the present disclosure.

Terms such as “determining” used in the present disclosure may include various operations of various types. The “determining”, for example, may include a case in which judging, calculating, computing, processing, deriving, investigating, looking up, search, and inquiry (for example, looking up a table, a database, or any other data structure), or ascertaining is regarded as “determining”. In addition, “determining” may include a case in which receiving (for example, receiving information), transmitting (for example, transmitting information), input, output, or accessing (for example, accessing data in a memory) is regarded as “determining”. Furthermore, “determining” may include a case in which resolving, selecting, choosing, establishing, comparing, or the like is regarded as “determining”. In other words, “determining” includes a case in which a certain operation is regarded as “determining”. In addition, “determining” may be rephrased with “assuming”, “expecting”, “considering”, and the like.

Terms such as “connected” or “coupled” or all the modifications thereof mean all the kinds of direct or indirect connection or coupling between two or more elements and may include presence of one or more intermediate elements between two elements that are mutually “connected” or “coupled”. Coupling or connection between elements may be physical coupling or connection, logical coupling or connection, or a combination thereof. For example, “connection” may be rephrased with “access”. When used in the present disclosure, two elements may be considered as being mutually “connected” or “coupled” by using at least one of one or more wires, a cable and a print electric connection and, as several non-limiting and non-comprehensive examples, by using electromagnetic energy having wavelengths in a radio frequency region, a microwave region, and a light (both visible light and non-visible light) region.

Description of “on the basis of” used in the present disclosure does not mean “only on the basis of” unless otherwise mentioned. In other words, description of “on the basis of” means both “only on the basis of” and “on the basis of at least.”

In the present disclosure, in a case in which names such as “first,” “second,” and the like is used, referring to each element does not generally limit the amount or the order of such an element. Such names may be used in the present disclosure as a convenient way for distinguishing two or more elements from each other. Accordingly, referring to the first and second elements does not mean that only the two elements can be employed therein or the first element should precede the second element in a certain form.

In the configuration of each device described above, a “means” may be substituted with a “unit,” a “circuit,” a “device,” or the like.

In a case in which “include,” “including,” and modifications thereof are used in the present disclosure, such terms are intended to be inclusive like a term “comprising.” In addition, a term “or” used in the present disclosure is intended to be not an exclusive logical sum.

In the present disclosure, for example, in a case in which an article such as “a,” “an,” or “the” in English is added through a translation, the present disclosure may include a plural form of a noun following such an article.

In the present disclosure, a term “A and B are different” may mean that “A and B are different from each other.” In addition, the term may mean that “A and B are different from C.” Terms “separated,” “combined,” and the like may be interpreted similar to “different.”

### REFERENCE SIGNS LIST

1 demand prediction device

10 information storing unit

11 normal state demand prediction model generating unit

12 unusual state demand prediction model generating unit

13 demand distribution generating unit

14 state prediction model generating unit

15 demand predicting unit

1. A demand prediction device comprising processing circuitry configured to:
store a plurality of demand prediction models, each of the demand prediction models being a prediction model configured to predict a demand in a demand state relating to demand and differing between each demand prediction model and a state prediction model that is a prediction model predicting a state degree that is a degree to which a designated timing is applicable to each demand state; and
predict a demand on the basis of the demands predicted by the stored plurality of demand prediction models and the state degree predicted by the stored state prediction model.

2. The demand prediction device according to claim 1, wherein the processing circuitry predicts the demand on the basis of the demands predicted by each of the plurality of demand prediction models for a designated timing and the state degree predicted by the state prediction model for the timing.

3. The demand prediction device according to claim 1, wherein the state prediction model is a prediction model generated on the basis of a demand distribution, which is a probability distribution of a demand, based on the demands predicted by each of the plurality of demand prediction models.

4. The demand prediction device according to claim 3, wherein the state prediction model is a prediction model generated on the basis of positions of the demands predicted by each of the plurality of demand prediction models in the demand distribution.

5. The demand prediction device according to claim 1, wherein the processing circuitry further configured to generate the state prediction model,
wherein the processing circuitry stores the generated state prediction model.

6. The demand prediction device according to claim 1, wherein the processing circuitry predicts the demand by weighting state degrees predicted by the state prediction models for demands predicted by each of the plurality of demand prediction models.

7. The demand prediction device according to claim 1, wherein the plurality of demand prediction models include at least one of a prediction model predicting a demand in a case in which the demand is in a normal state and a prediction model predicting a demand in a case in which the demand is in an unusual state.

8. The demand prediction device according to claim 2, wherein the state prediction model is a prediction model generated on the basis of a demand distribution, which is a probability distribution of a demand, based on the demands predicted by each of the plurality of demand prediction models.
